(19) United States
(12) Patent Application Publication
(10) Pub. No.: US 2002/0027197 A1
(43) Pub. Date: Mar. 7, 2002

(54) Multiple source electrospray ionization for mass spectrometry

(76) Inventors: Wayne K. Duholke, Kalamazoo, MI (US); Bruce A. Stiemsma, Battle Creek, MI (US)

Correspondence Address: MUETING, RAASCH & GEBHARDT, P.A., P.O. BOX 581415, MINNEAPOLIS, MN, 55458, US

(21) Appl. No.: 09/874,742

(22) Filed: Jun. 5, 2001

Related U.S. Application Data
(60) Provisional application No. 60/209,350, filed on Jun. 5, 2000.

(51) Int. Cl. H01J 49/00; B01D 59/44

(52) U.S. Cl. 250/288

(57) ABSTRACT

Electrospray ionization mass spectrometry systems and methods are disclosed in which multiple source materials may be introduced into a mass spectrometer at the same time without mixing the different source materials. Integrity of a sample material may be maintained before and during analyses that require the introduction of a reference material at the same time as the sample material. Independent control may be obtained over, e.g., the voltage level of the different source materials, flow rates of the different source materials through the different capillaries, and alignment of the different capillaries used to introduce each of the source materials.

This application claims the benefit of U.S. Provisional Application Ser. No. 60/209,350, filed Jun. 5, 2000, which is incorporated herein by reference in its entirety.

### FIELD OF THE INVENTION

The present invention relates to electrospray ionization sources for mass spectrometry. More particularly, the present invention provides multiple source electrospray ionization systems and methods of using the same.

### BACKGROUND OF THE INVENTION

Mass spectrometry is typically used for identification of chemical structures, molecular weights, determination of mixtures, and quantitative elemental analysis, based on the application of the mass spectrometer. Molecular weights and structural information of organic molecules may be determined using mass spectrometry based on the augmentation pattern of molecular fragments and the ions formed when the molecule undergoes ionization. The weights of molecules may be measured by ionizing the molecules and measuring their trajectories in response to electric and magnetic fields in a vacuum.

Organic molecules having a molecular weight greater than about a few hundred to few thousand are of great medical and commercial interest as they include, for example, peptides, proteins, DNA, oligosaccharides, commercially important polymers, organometallic compounds and pharmaceuticals. Large organic molecules, of molecular weight over 10,000 Daltons, may be analyzed in a quadrupole mass spectrometer using “electrospray” ionization to introduce the ions into the spectrometer.

Electrospray ionization mass spectrometry (ESI/MS) is a significant tool in the study of proteins and protein complexes. Electrospray ionization as a method of sample introduction for mass spectrometric analysis is also known. Generally, electrospray ionization is a method in which ions are formed at atmospheric pressure and then introduced into a mass spectrometer. In electrospray ionization, a sample solution containing molecules of interest may be pumped through an electrically conductive hypodermic needle and into an electrospray chamber. An electrical potential of several kilovolts may be applied to the needle to generate a fine spray of charged droplets. The droplets may be sprayed at atmospheric pressure into a chamber that may contain a heated gas to vaporize the solvent. The fine spray of highly charged droplets releases molecular ions as the droplets vaporize. The ions are then transported into the mass spectrometer and analyzed.

High Resolution Mass Spectrometry (HRMS) is used to obtain the accurate mass of chemical entities to allow determination of their empirical formulae. One problem associated with HRMS is the need to supply reference material at the same time as the sample material to ensure accuracy of the measurements. In an ESI/MS process, the reference material is typically added to the sample material and both of the materials are introduced into the electrospray chamber through a single capillary.

Direct addition of the reference material to the sample normally requires that HRMS be performed last in any series of mass spectrometry analyses when only small amounts of the sample material remain. The reference material may, however, produce ions that interfere with those of the sample material or the reference material may suppress the sample material ions. Regardless, discovery of the problems with the reference material often occurs at a time when insufficient amounts of the sample material (free of the problematic reference material) remain to conduct the entire series of analyses with a different reference material.

### SUMMARY OF THE INVENTION

The present invention provides systems and methods for electrospray ionization mass spectrometry in which multiple source materials may be introduced into a mass spectrometer at the same time without mixing the different source materials before their introduction to the mass spectrometer. As a result, integrity of a sample material may be maintained before and during analyses that require the introduction of two different source materials at the same time, e.g., a reference material and an analyte of interest.

Another advantage of the systems and methods of the present invention is that the voltage levels of the source materials may, if desired, be independently controlled to improve ionization of the different source materials.

Still another advantage of the systems and methods of the present invention is that the flow rates of the different source materials through the different capillaries used to introduce each of the source materials may, if desired, be independently controlled to improve ionization of the different source materials.

Yet another advantage of the systems and methods of the present invention is that the location and orientation of the different capillaries used to introduce each of the source materials may, if desired, be independently controlled to improve ionization of the different source materials and/or delivery of the ionized materials to the mass spectrometer.

In one aspect, the present invention provides an electrospray ionization system for a mass spectrometer, the system including first and second capillaries. The first capillary includes a distal opening proximate a mass spectrometer inlet. First source material is in fluid communication with the first capillary. The second capillary includes a distal opening proximate the mass spectrometer inlet. Second source material is in fluid communication with the second capillary.

In another aspect, the present invention provides an electrospray ionization system for a mass spectrometer, the system including first and second capillaries. The first capillary includes a distal opening proximate a mass spectrometer inlet. First source material is in fluid communication with the first capillary. A first capillary alignment mechanism aligns the first capillary with the mass spectrometer inlet. A first flow rate controller is in fluid communication with the first capillary, whereby flow rate of the first source material through the first capillary can be controlled. A first capillary voltage source is in electrical communication with the first source material. The second capillary includes a distal opening proximate the mass spectrometer inlet. Second source material is in fluid communication with the second capillary. A second capillary alignment mechanism aligns the second capillary with the mass spectrometer inlet. A second flow rate controller is in fluid communication with the second capillary, whereby flow rate of the second source material through the second capillary can be controlled. A second capillary voltage source is in electrical communication with the second source material.

In another aspect, the present invention provides a method of supplying electrosprayed ions of a first source material and a second source material to a mass spectrometer. The method includes providing a first capillary having a distal opening proximate a mass spectrometer inlet, the first capillary in fluid communication with first source material. A second capillary is also provided that includes a distal opening proximate the mass spectrometer inlet. The second capillary is in fluid communication with a second source material. The first source material is held at a first voltage level and the second source material is held at a second voltage level. The first source material is sprayed into the mass spectrometer inlet through the first capillary and the second source material is sprayed into the mass spectrometer inlet through the second capillary.

These and other features and advantages of the systems and methods of the present invention are described in more detail with reference to the illustrative embodiments of the invention discussed below.

### BRIEF DESCRIPTION OF THE DRAWINGS

FIG. 1 is a schematic diagram of one dual source electrospray system according to the present invention and an associated mass spectrometer.

FIG. 2 is a more detailed schematic diagram of one dual source electrospray system according to the present invention and an associated mass spectrometer.

FIG. 3 illustrates a dual source electrospray system according to the present invention along a z-axis.

FIG. 4 illustrates the electrospray system of FIG. 3 along the y-axis.

FIG. 5 illustrates construction of one capillary system useful in connection with the present invention.

### DESCRIPTION OF ILLUSTRATIVE EMBODIMENTS OF THE INVENTION

The present invention provides systems and methods for electrospray ionization mass spectrometry in which multiple source materials may be introduced into a mass spectrometer at the same time without mixing the different source materials before introduction into the mass spectrometer. As a result, integrity of, e.g., an analyte of interest may be maintained before and during analyses that require the introduction of a reference material at the same time as the analyte of interest.

FIG. 1 depicts one illustrative embodiment of an electrospray system 10 and a mass spectrometer 12 having an inlet 14 for receiving the materials to be analyzed. The mass spectrometer or analyzer 12 may be of various types, e.g., sector mass, quadrupole mass filter, ion trap, Fourier transform ion cyclotron resonance (FT-CIR), time-of-flight, etc. With the exception of FT-CIR mass spectrometers, in which a repetitive signal is induced in receiver plates by orbiting ions, the detection of ions after mass analysis is performed by measuring the emitted ions, electrons, or photons that result from the energy of ions colliding with the detector surfaces. Those measurements may be performed with a variety of different detectors. Regardless of their precise construction, mass spectrometers typically include an inlet into which ions of the sample and any reference materials are introduced for measurement according to the principles of operation of the specific mass spectrometer being used.

One mass spectrometer with which the present invention may be used is a FINNIGAN MAT 900 Sector Field Mass Spectrometer (with normal E/B geometry and an ESI-2 electrospray ionization chamber and controller, manufactured by ThermoQuest Corporation, Austin, Tex.). This mass spectrometer includes a stainless steel inlet tube that may be heated and/or held at a desired voltage during introduction of materials to be analyzed by the mass spectrometer.

The present invention provides an electrospray system for producing ions from multiple source materials that are suitable for detection and measurement by a mass spectrometer. Although the methods and systems of the present invention are described below in connection with a dual or two source electrospray ionization system 10, any suitable number of sources may be introduced into the mass spectrometer 12 using the electrospray system of the present invention. For example three, four, or more different sources may be provided in accordance with the principles of the present invention and the illustrative examples including only two sources should not be construed as limiting the present invention. Furthermore, although various embodiments of the invention may be described as using two sources that include an analyte of interest and a reference material, the different source materials may all be analytes of interest where no reference material is required.

Referring now to FIG. 1, a schematic diagram of one electrospray system 10 according to the present invention includes two sources 20a and 20b of materials (collectively referred to below as sources 20) to be analyzed by mass spectroscopy. The sources 20 may, for example, include an analyte of interest 20a and a reference material 20b that can be separately and independently introduced into the mass spectrometer 12 (through mass spectrometer inlet 14).

The introduction of different source materials into the same mass spectrometer either sequentially or simultaneously can provide a number of advantages. For example, source 20b may be a reference material that can be used to perform High Resolution Mass Spectrometry (HRMS) to obtain the accurate mass of the analyte material in source 20a. By supplying the reference material 20b independently of the analyte material 20a, the integrity of the analyte material 20a is maintained during HRMS. As discussed above, maintaining the integrity of the analyte material during HRMS may provide a number of advantages including, but not limited to, eliminating sample suppression caused by competition from the reference material, allowing for the substitution of different reference materials if interference is present at the mass of the analyte material ions, allowing for further testing of the analyte material (uncontaminated by the reference material), etc.

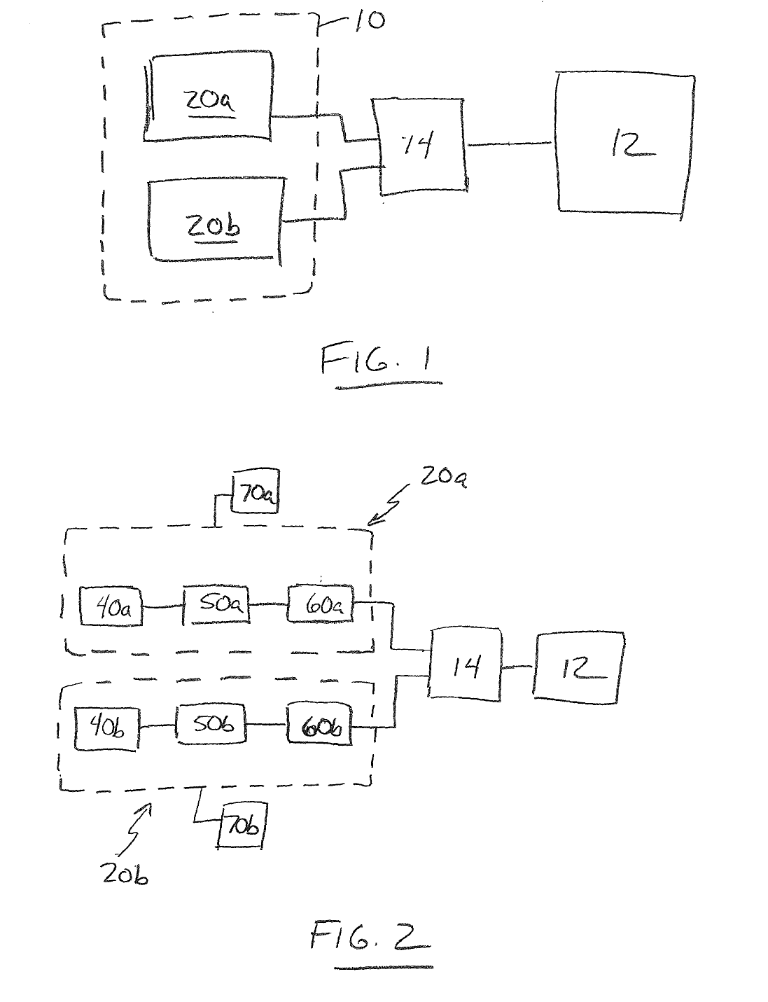

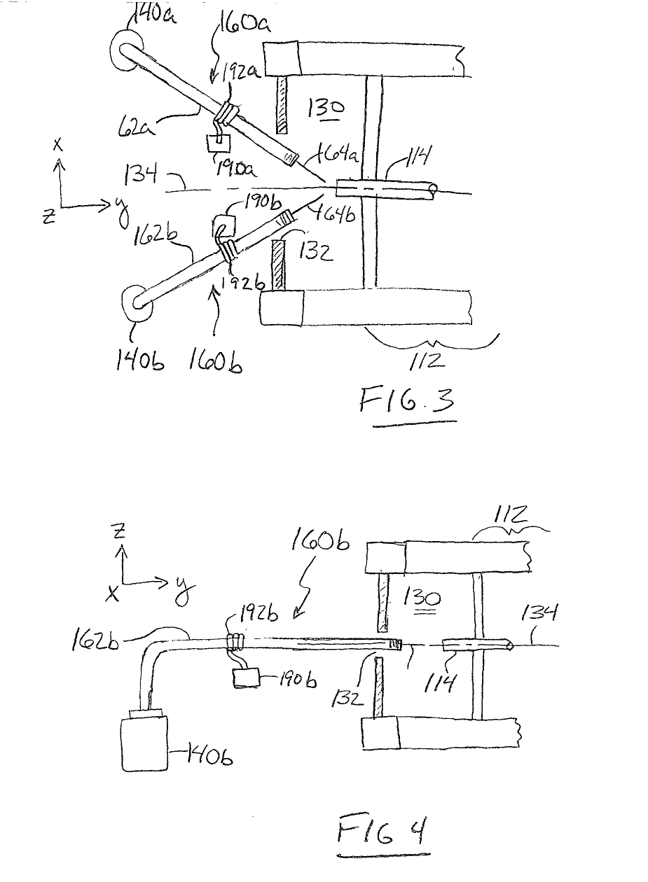

In addition to the advantages associated with maintaining analyte integrity, the present invention also provides a number of advantages that can be discussed in connection with the more detailed schematic diagram of FIG. 2. Source 20a includes a container 40a of the selected reference material and is in fluid communication with a capillary 60a through a flow control device 50a. Capillary 60a is held at a desired voltage by voltage source 70a. Although not specifically described below, source 20b preferably includes similar components including a container 40b, flow control 50b, capillary 60b, and voltage supply 70b that operate in a similar manner.

Referring back to source 20a, capillary 60a is positioned with a distal opening proximate the inlet 14 of the mass spectrometer 12. As used herein, the distal openings of the capillaries are “proximate the mass spectrometer inlet” when they are located such that the sprayed material exiting each capillary enters the mass spectrometer inlet 14 in sufficient amounts for analysis by the mass spectrometer.

A pump or other suitable device or mechanism (not shown) may be used to deliver the material from the container 40a, through the flow control device 50a and to the distal end of the capillary 60a for spraying into the mass spectrometer inlet 14. Also included is a voltage supply 70a that provides a desired voltage level (relative to, e.g., ground) for source 20a such that, upon exiting the capillary 60a, the sprayed particles are ionized.

The voltage supplied by the voltage source 70a may be applied to the source material at any suitable location along the flow path of the source material. As used in connection with the present invention, the voltage source 70a may be described as being in electrical communication with the capillary 60a, regardless of the exact location at which the voltage is physically supplied. For example, if the capillary 60a is electrically conductive (e.g., in the form of a metallic needle) that voltage can be applied at the needle. If the capillary 60a itself is not electrically conductive, the voltage may be applied directly to the material in the container 40a or at any other point along the capillary. Other variations may also be possible.

Independent control over flow rate of the materials through the capillaries 60a and 60b using, respectively, independent flow control devices 50a and 50b can provide additional advantages in that it may be desirable to supply the different source materials at different rates (or not at all) during different portions of the testing protocols. The flow control devices 50a and 50b may include any suitable mechanism used to control flow of liquids including, but not limited to, e.g., valves, metering pumps, constriction mechanisms, pressurized vessels, etc. If flow control device 50a/50b is provided in the form of a pump, e.g., metering pump, it may not be necessary to provide a separate pumping mechanism in addition to the flow control device.

Independent control over voltage levels between the different capillaries 60a and 60b using, respectively, independent voltage supplies 70a and 70b can provide additional advantages in that it may be desirable to supply the different materials at the same or different voltage levels to enhance (or suppress) ionization. Independent voltage control will typically require electrical isolation between the two capillaries 60a and 60b.

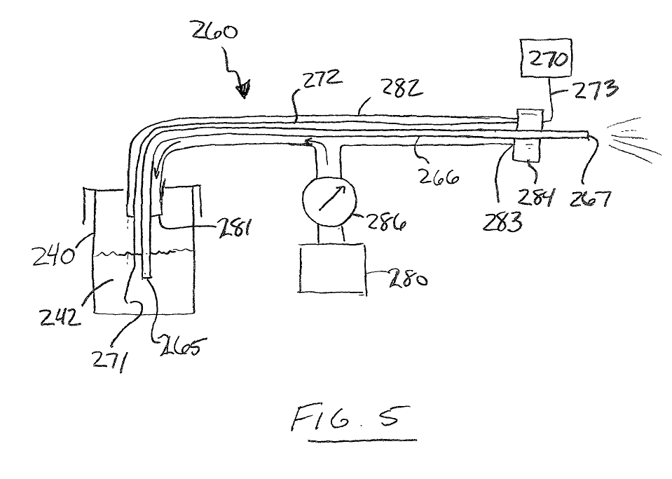

Referring now to FIGS. 3 and 4, one illustrative dual source electrospray system will be described in more detail. FIG. 3 is a view of the illustrative system along the z-axis from above the x-y plane (see reference axes) and FIG. 4 is a view of the same system along the x-axis (see reference axes). Although the details of construction and operation of only of the sources are discussed below, it will be understood that the construction and operation of the other source are similar.

The capillary 160a preferably includes a length of tubing 162a in fluid communication with a container 140a at a proximal end and, e.g., an electrospray needle 164a at its distal end. The electrospray needle 164a is positioned to feed the materials from container 140a into the mass spectrometer inlet 114 through opening 132 in an optional electrospray chamber 130. The needle 164a and other portions of the device may preferably be of any of the conventional designs used in known electrospray ionization systems. More details regarding one exemplary construction are described below with respect to FIG. 5.

The tubing 162a may preferably be provided in the form of a length of fused silica tubing or any other material that provides the appropriate level of electrical isolation between the capillary 160a and the rest of the system. Electrical isolation is required because the source material within capillary 160a is preferably held at a voltage with respect to, e.g., ground, to ionize the particles exiting the needle 164a.

As the solution from the container 140a exits from the needle 164a, a fine spray of highly charged droplets is produced. As these droplets vaporize upon entering the electrospray chamber 130, molecular ions are released from the droplets into the gas phase in accordance with known principles. Both needles 164a and 164b are preferably directed towards inlet tube 114 that is in communication with the mass spectrometer 112. At least some of the ions thus formed are delivered to the mass spectrometer 112 as discussed above with respect to FIGS. 1 and 2. The voltage supply 170a is regulated during the electrospray process to maintain a voltage level that is sufficient to ionize the sprayed particles.

In addition to adjusting the flow rate and voltage levels, it may also be desirable to adjust the alignment of the capillary 160a with respect to the inlet tube 114. Among the various adjustments that may be made include the distance of the distal end of the capillary 160a (e.g., the end of the electrospray needle 164a) from the inlet tube 114. It may be preferred that the spacing between the distal end of the capillary 160a and the opening of the inlet tube 114 be about 5 millimeters, although actual spacing will vary based on a variety of factors including, but not limited to: flow rate through the capillary, size of the capillary and inlet tube, vacuum within the mass spectrometer, voltage levels, the number of sources being directed into the inlet tube, etc.

In addition to distance from the inlet tube 114, the orientation of the capillary 160a relative to an axis 134 that is aligned with the inlet tube 114 may also be adjusted. In a conventional system, a single capillary is typically aligned with the inlet tube 114 along the axis 134, i.e., parallel to the y-axis and perpendicular to the x-axis in FIG. 3 and parallel to the y-axis and perpendicular to the z-axis in FIG. 4. In the present invention, however, at least two capillaries with distal ends proximate the inlet 114 are provided and at least one of the capillaries 160a and 160b is oriented off of the axis 134 to allow for, e.g., simultaneous introduction of two or more different source materials into the inlet tube 114. It may be preferred that all of the capillaries be oriented or aligned off of the axis 134 (as illustrated in FIGS. 3 and 4).

One suitable alignment mechanism that can be used to align the capillaries 160 is illustrated in FIGS. 3 and 4. The alignment mechanism includes a deformable support 192a and 192b that extends from a base 190a and 190b to the associated capillary 160a and 160b. The bases 190a and 190b are preferably held in a fixed position relative to the inlet tube 114 during operation of the system. By deforming the support 192a and 192b, the alignment of the associated capillary 160a and 160b can be adjusted and maintained in a desired orientation relative to the inlet tube 114. One non-limiting example of a suitable deformable support is a copper wire (shown wrapped around each of the capillaries) which can be deformed to fixed position as desired, although any deformable support may be used to position the capillaries. Examples of other suitable deformable supports may include, for example, gooseneck mechanisms, aluminum wire, etc.

Referring now to FIG. 5, one example of a capillary 260 that may be used in connection with the present invention is illustrated in more detail. The capillary 260 does not include a needle as do the capillaries described with respect to FIGS. 3 and 4, although such a separate structure could be provided if desired. Rather, the capillary 260 includes a length of source tubing 266 located within a larger outer sheath 282. The source tubing 266 includes a proximal opening 265 within the source material 242 and a distal opening 267 at the distal end of the capillary 260.

The outer sheath 282 includes a proximal opening 281 within the container 240 in which the source material 242 is located. The opening 281 may preferably be outside of the source material 242 to, e.g., avoid introducing bubbles in the source material 242. The distal end 283 of the outer sheath 282 preferably terminates and is sealed by a fitting 284 through which the source tubing 266 extends.

A source of pressurized gas 280 is in fluid communication with the interior of the sheath 282 through, e.g., a tee-fitting as depicted. The pressure of the gas within the sheath 282 is controlled by, e.g., a regulator 286. By controlling the pressure of the gas within the sheath 282, the pressure within the sealed container 240 is also controlled (because the sheath 282 opens into the container 240). The gas pressure within the space above the solution 242 in the container 240 provides the motive force required to move the source material 242 into the proximal end 265 of the source tubing 266 until it exits from the distal end 267. The gas 280 may preferably be non-reactive with the source material 242, e.g., nitrogen, etc. By controlling the pressure within the container 240, the flow rate of the source material 242 through the source tubing 266 can be controlled. Alternative constructions may also be possible, e.g., the gas pressure may be delivered directly to the container 240, with the source tubing 266 traveling outside of the sheath 282.

Where the source tubing 266 terminates in an opening from which the sprayed source material exits for delivery to the mass spectrometer inlet, it preferably has a relatively small diameter at the distal end 267. For example, the inside diameter of the source tubing 266 at its distal end 267 may be about 15 micrometers. Dimensions will vary based on a variety of factors such as the solution to be delivered, desired flow rates, etc.

The source tubing 266 may be made of a variety of materials that will be known to those skilled in the art. One suitable material is a fused silica tubing. If the source tubing 266 is not electrically conductive as, e.g., fused silica tubing, then a separate conductive path must be used to provide the desired voltage level for the source material 242 being sprayed from the tubing 266.

In the illustrated embodiment, a conductive wire 272 is threaded through the interior of the sheath 282 such that the proximal end 271 of the wire 272 terminates within the source material 242. The distal end 273 of the wire 272 is connected to a suitable voltage source 270. As a result, the source material 242 can be held at a desired voltage level with respect to, e.g., ground. In the illustrated apparatus, the wire 272 extends through the fitting 284 at the distal end 283 of the outer sheath 282 . Many other configurations can, however, be used in place of the illustrated arrangement.

The preceding specific embodiments are illustrative of the practice of the invention. This invention may be suitably practiced in the absence of any element or item not specifically described in this document. The complete disclosures of all patents, patent applications, and publications cited herein are incorporated into this document by reference as if individually incorporated in total.

Various modifications and alterations of this invention will become apparent to those skilled in the art without departing from the scope of this invention, and it should be understood that this invention is not to be unduly limited to illustrative embodiments set forth herein, but is to be controlled by the limitations set forth in the claims and any equivalents to those limitations.

What is claimed is:

1. An electrospray ionization system for a mass spectrometer, the system comprising:
a first capillary comprising a distal opening proximate a mass spectrometer inlet;
a first source container in fluid communication with the first capillary;
a second capillary comprising a distal opening proximate the mass spectrometer inlet; and
a second source container in fluid communication with the second capillary.

2. The system of claim 1, further comprising a first capillary alignment mechanism aligning the first capillary with the mass spectrometer inlet.

3. The system of claim 2, wherein the first capillary alignment mechanism comprises a deformable support.

4. The system of claim 1, further comprising a second capillary alignment mechanism aligning the second capillary with the mass spectrometer inlet.

5. The system of claim 4, wherein the second capillary alignment mechanism comprises a deformable support.

6. The system of claim 1, further comprising a first flow rate controller in fluid communication with the first capillary, whereby flow rate through the first capillary can be controlled.

7. The system of claim 1, further comprising a second flow rate controller in fluid communication with the second capillary, whereby flow rate through the second capillary can be controlled.

8. The system of claim 1, further comprising a first voltage source in electrical communication with the first capillary.

9. The system of claim 1, further comprising a second voltage source in electrical communication with the second capillary.

10. The system of claim 1, wherein the first source container comprises an analyte of interest and the second source container comprises a reference material.

11. The system of claim 1, wherein the mass spectrometer inlet and distal openings of the first and second capillaries are located within an electrospray chamber.

12. An electrospray ionization system for a mass spectrometer, the system comprising:
a first capillary comprising a distal opening proximate a mass spectrometer inlet;
a first source container in fluid communication with the first capillary;
a first capillary alignment mechanism aligning the first capillary with the mass spectrometer inlet;
a first flow rate controller in fluid communication with the first capillary, whereby flow rate through the first capillary can be controlled;
a first voltage source in electrical communication with the first capillary;
a second capillary comprising a distal opening proximate the mass spectrometer inlet;
a second source container in fluid communication with the second capillary;
a second capillary alignment mechanism aligning the second capillary with the mass spectrometer inlet;
a second flow rate controller in fluid communication with the second capillary, whereby flow rate through the second capillary can be controlled; and
a second voltage source in electrical communication with the second capillary.

13. A method of supplying electrosprayed ions of a first source material and a second source material to a mass spectrometer comprising:
providing a first capillary comprising a distal opening proximate a mass spectrometer inlet, the first capillary in fluid communication with first source material;
providing a second capillary comprising a distal opening proximate the mass spectrometer inlet, the second capillary in fluid communication with second source material;
holding the first source material at a first voltage level;
holding the second source material at a second voltage level;
spraying the first source material into the mass spectrometer inlet through the first capillary; and
spraying the second source material into the mass spectrometer inlet through the second capillary.

14. The method of claim 13, further comprising spraying the first source material and the second source material into the mass spectrometer inlet at the same time.

15. The method of claim 13, further comprising spraying the first source material and the second source material into the mass spectrometer inlet at different times.

16. The method of claim 13, wherein the first voltage level and the second voltage level are the same.

17. The method of claim 13, wherein the first voltage level and the second voltage level are different.

18. The method of claim 13, further comprising spraying the first source material into the mass spectrometer inlet at a first flow rate and spraying the second source material into the mass spectrometer inlet at a second flow rate, wherein the first flow rate and the second flow rate are the same.

19. The method of claim 13, further comprising spraying the first source material into the mass spectrometer inlet at a first flow rate and spraying the second source material into the mass spectrometer inlet at a second flow rate, wherein the first flow rate and the second flow rate are different.

20. The method of claim 13, further comprising adjusting alignment of the first capillary with the mass spectrometer inlet.

21. The method of claim 20, wherein the adjusting comprises deforming a deformable support.

22. The method of claim 13, further comprising adjusting alignment of the second capillary with the mass spectrometer inlet.

23. The method of claim 22, wherein the adjusting comprises deforming a deformable support.

24. The method of claim 13, further comprising adjusting alignment of the first capillary with the mass spectrometer inlet independently of the second capillary.

25. The method of claim 13, further comprising adjusting alignment of the second capillary with the mass spectrometer inlet independently of the first capillary.

26. The method of claim 13, wherein the first source material comprises an analyte of interest and the second source material comprises a reference material.
